(19) United States
(12) Patent Application Publication
(10) Pub. No.: US 2002/0129080 A1
(43) Pub. Date: Sep. 12, 2002

(54) Method of and system for running an algorithm

(76) Inventors: Christian Hentschel, Eindhoven (NL); Cornelis Adrianus Maria Van Zon, Peekskill, NY (US); Shaomin Peng, Yorktown Heights, NY (US); Zhun Zhong, Croton-on-Hudson, NY (US); Maria Gabrani, Eindhoven (NL); Elisabeth Francisca Maria Steffens, Eindhoven (NL); Reinder Jaap Bril, Eindhoven (NL)

Correspondence Address: Corporate Patent Counsel, U.S. Philips Corporation, 580 White Plains Road, Tarrytown, NY, 10591, US

(21) Appl. No.: 09/759,036

(22) Filed: Jan. 11, 2001

(51) Int. Cl. G06F 9/00

(52) U.S. Cl. 709/102

(57) ABSTRACT

Nowadays, programmable components (604), rather than dedicated single-function components can perform continuous media processing in consumer devices, like digital television sets (610), set-top boxes, PCs, or VCRs. The media processing algorithms that are written for those programmable components (604), must be designed to provide a plurality of output quality levels in exchange for required processing resources. Since resources are finite, the media processing algorithms must be controlled in their resource usage and the output quality level they provide. Users of consumer devices do not like to see major changes in the quality of, for example, a video they are watching. Therefore, typical algorithm characteristics like the functions an algorithm comprises, the resource usage per function and the quality level per function are used to provide smoother quality transitions.

The invention relates to a method of running an algorithm wherein the algorithm comprises a first function and a second function.

Furthermore the invention relates to a system for running an algorithm wherein the algorithm comprises a first function and a second function.

An embodiment of the method and the system of the kind set for above is known from Scalable Video Decoder and its Application to Multi-channel Multicast system (IEEE 19th International conference on consumer electronics, year 2000, Page 232 to 23; Here, a scalable algorithm is described to be used within real time systems that have limited resources and time critical algorithms. An example of a real time system with these characteristics is a video decoder to be used within a multi-channel multicast system and examples of limited resources arc a physical memory, a main processor, and an input/output device. The scalable algorithm, for example a decoding algorithm for video, comprises a plurality of functions like, for example low pass filtering and upsampling. For each function the resource requirement in terms of CPU load is determined per number of video channels, for example 1, 4, or 8 channels, that can be decoded simultaneously. The functions that can be used within the algorithm are derived from the allowed CPU load and the budget each function is allowed to use must be allocated to each function individually.

It is an object of the current invention to provide a method as set font above that allocates the resources in an improved way. To achieve this object, the method according to the invention comprises the following steps;

a first step of requesting an algorithm resource by the algorithm to provide a plurality of output quality levels,

a second step of determining that the first function provides a first plurality of quality levels and the second function provides a second plurality of quality levels,

a third step of allocating a budget to the algorithm to enable operating the algorithm at a output quality level, said output quality level being one of the plurality of output quality levels,

a fourth step of assigning a first quality level of the first plurality of quality levels to the first function and of assigning a second quality level of the second plurality of quality levels to the second function. By allocating a budget to an algorithm as a whole, a budget manager, or overall system control does not need to know that the algorithm comprises of a plurality of functions. The overall system control can therefore be used for the general purpose of allocating a budget to algorithms that run on the system simultaneously. The budget is based upon the requested algorithm resources. Instead of allocating a budget to the algorithm, the overall system control can set an output quality level to the algorithm as a whole. The output quality level can be chosen from the plurality of output quality levels the algorithm can provide. Each function of the algorithm can provide a plurality of quality levels. When an algorithm gets allocated a budget or is assigned an output quality, a quality control can assign a corresponding quality level or setting to each function. The corresponding quality level or setting is chosen from the plurality of quality levels that can be provided by a function. The quality level of the function that provides the highest output quality level of the algorithm for the allocated budget can be the preferred choice from the plurality of quality levels that can be provided by a function. The quality control distributes implicitly its allocated budget over the functions the algorithm comprises by the assignment of a corresponding quality level or setting to each function. The assigned quality level per function is based upon the budget that is allocated to the algorithm.

An embodiment of the method according to the invention is described in claim 2. A function can provide a quality level for a plurality of levels of complexity wherein a level of complexity for example is determined by a number of mathematical operations a function can perform, an amount of memory the function requires or communication means, like bandwidth, the function requires. When the algorithm consists of a plurality of functions, each function providing a plurality of quality levels, there are a lot of combinations of level of complexity and quality level possible. A quality control can perform these combinations and can decide upon these combinations which quality level to assign to a function. Furthermore, the knowledge about the complexity of a function while providing the same quality level can lead to more smooth output quality transitions of the algorithm as a whole.

An embodiment of the method according to the invention is described in claim 3. Each function can operate at its own quality level. A combination of the first function and the second function can lead to one algorithm that can provide a plurality of output quality levels. When a new budget is allocated to an algorithm which leads to a different output quality level, the same algorithm can be operated again, by allocating new quality levels to the first and second function as previously described. A number of algorithms providing a same functionality but at a different output quality level that can, for example, be operated in parallel, can be limited this way.

An embodiment of the method according to the invention is described in claim 4. A quality control, for example can choose for each function the lowest complexity for the highest quality level from the plurality of combinations of complexity and quality level per function.

An embodiment of the method according to the invention is described in claim 5. When the allocated budget is substantially equal to the requested algorithm resource, the algorithm does not get allocated substantially more than its requested algorithm resource. This prevents resources being not used by the algorithm, which can cause rejection of other algorithms to operate because their requested resource is already allocated to the algorithm.

An embodiment of the method according to the invention is described in claim 6. When the first amount of resources in addition to the second amount of resources is substantially equal to the allocated budget, the algorithm does not use substantially more than its allocated budget. This prevents budget-overrun by the algorithm which may cause budget shortage of other algorithms or algorithms that can result in missing deadlines of these other algorithms or algorithms and degradation of an overall output quality.

An embodiment of the method according to the invention is described in claim 7. The output quality levels that can be provided by an algorithm can depend upon a hardware platform that the algorithm is operated upon. When, for example, the first function of the algorithm has specific hardware requirements, like for example the availability of a harddisk, the first function may be omitted when the hardware is not available.

A embodiment of the method according to the invention is described in claim 8. The output quality levels that can be provided by an algorithm can depend upon a software platform that the algorithm can access. When, for example, the first function of the algorithm has specific software platform requirements, like for example the availability of a linear interpolation algorithm, the first function may be operated differently when the linear interpolation algorithm is not available, for example by using an available cubic interpolation algorithm.

A further object of the invention is to provide in a system as set forth above that allocates the resources in an improved way. To achieve this object, the system according to the invention comprises: function means conceived to contain the first function of the algorithm and a second function of the algorithm. lookup means conceived to contain a plurality of output quality levels that can be provided by the algorithm, a first plurality of quality level settings of the first function and a second plurality of quality level settings of the second function.

Embodiments of the system according to the invention are described in claims 10 to 13.

The invention will be described by means of embodiments shown by the following drawings:

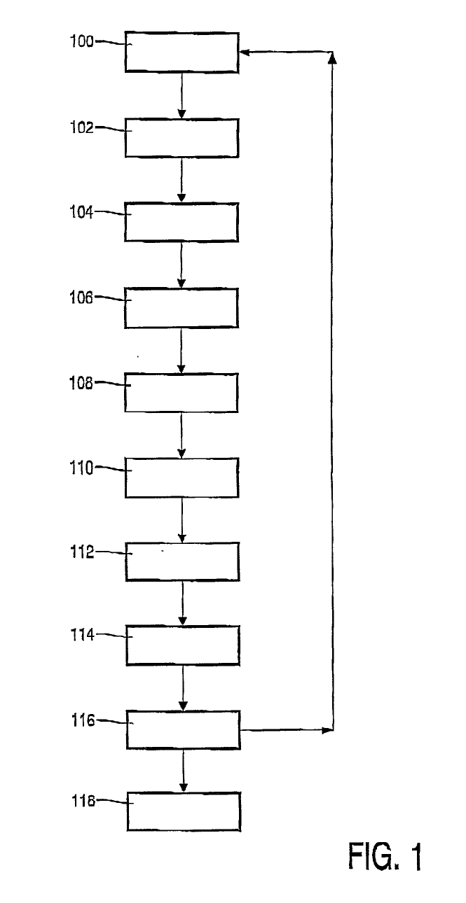

FIG. 1 illustrates an embodiment of the main steps of the method according to the invention,

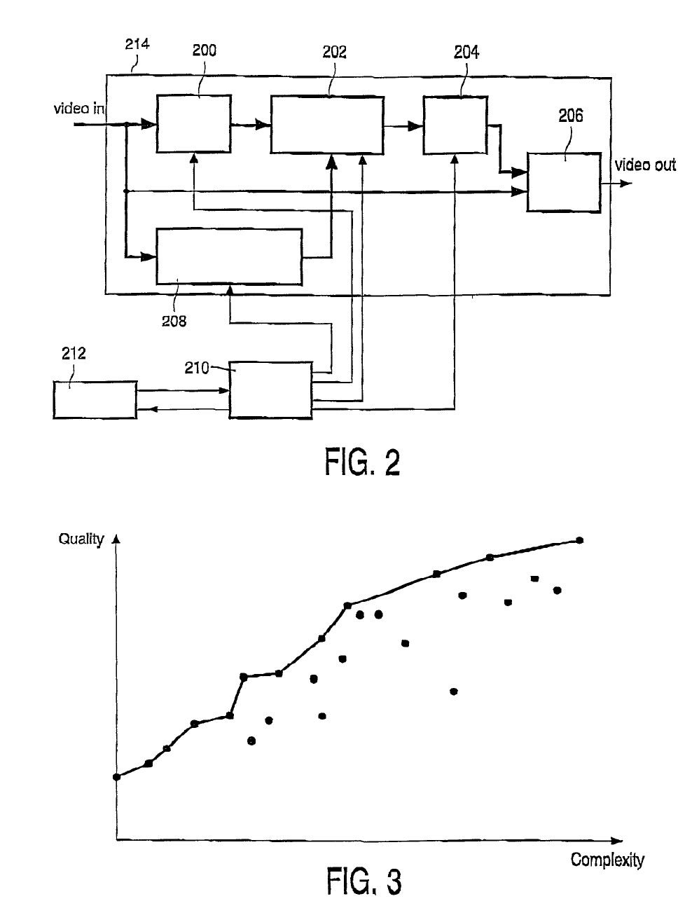

FIG. 2 illustrates an example of an algorithm that comprises a plurality of functions,

FIG. 3 illustrates an example of a diagram in which the complexity of the algorithm is set against the output quality level that can be provided by the algorithm,

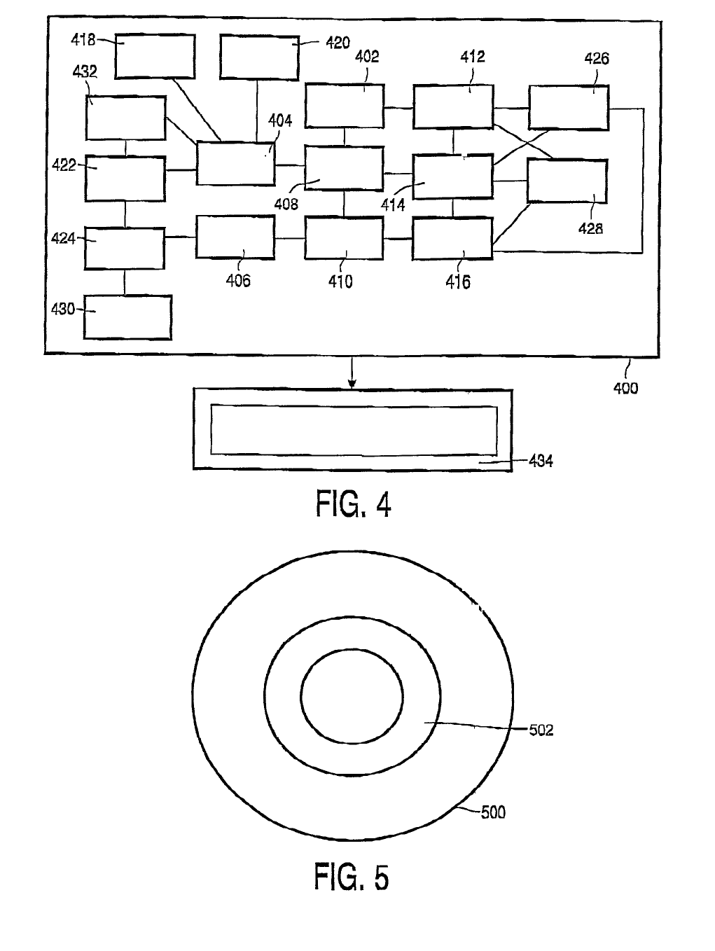

FIG. 4 illustrates the most important parts of an embodiment of the system according to the invention in a schematic way,

FIG. 5 illustrates a storage device in a schematic way that comprises an embodiment of a storage device comprising a computer program product arranged to perform the method according to the invention,

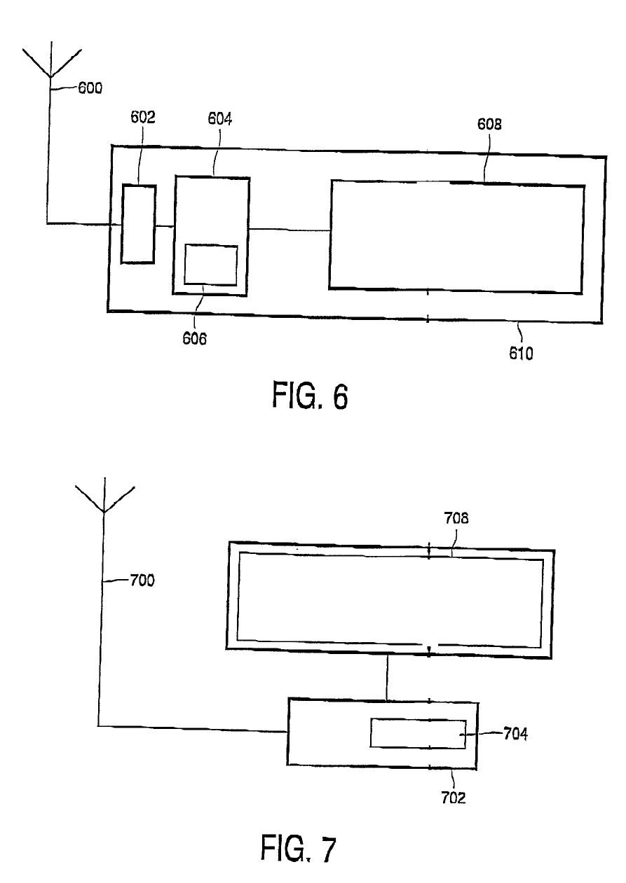

FIG. 6 illustrates a television set in a schematic way that contains an embodiment of the system according to the invention,

FIG. 7 illustrates a set-top box in a schematic way that contains an embodiment of the system according to the invention.

FIG. 1 illustrates an embodiment of the steps of the method according to the invention. Programmable components, rather than dedicated single-function components can perform continuous media processing. Those single-function components are used in traditional television receivers in which some of those single-function components could be combined to perform for example color decoding for NTSC or PAL systems, noise reduction or frame rate up-conversion. With the introduction of programmable components, continuous media processing algorithms can be implemented in software instead of hardware. Some of the expected advantages of the software implementation of media processing algorithms are: reduced time to market, re-use of hardware, re-use of software algorithms, portability, and flexibility. The software implementation of the media processing algorithms must run within the real-time environment in which system resources are finite and sufficient system resources may not be reserved for a particular processing algorithm, which can lead to changes in the output quality provided by the particular processing algorithm. Output quality levels can be measured by perception measurements, or objectively by available measurement means. A system running the processing algorithms is able to provide high-quality audio and video that has a relatively high frame rate above 50 Hz, almost no tolerance for frame rate fluctuations and a low tolerance for frame skips. Preferably, the system is also able to provide low frame rates with a maximum of 30 Hz, a high tolerance for frame rate fluctuations and a high tolerance for frame skips.

Algorithms can be allocated budget explicitly or implicitly by setting an output quality level of the algorithm. One of the objectives of an overall system control is to optimize the total output quality provided by the total system while making efficient use of all the available resources. The total output quality provided by the system depends amongst others upon the number of algorithms operating concurrently and the data an algorithm processes. The system may be, for example, a television, a PC, a display, a set-top box, or a VCR. In order to achieve this objective, the main steps below are performed

Here, step 100 is an initialization step in which an overall system control, for example a budget manager accesses the contents of a first lookup table as illustrated in Table 1. In this table, “CPU”, “co-processor” and “memory requirements” are examples of resources that an algorithm can use. Furthermore, a higher number that is denoted in the column named “quality number” indicates a better output quality level perceived by a user. By accessing the contents of this first lookup table, the overall system control determines the predefined amount of resources, for example CPU cycles, an algorithm requests to provide a predefined output quality level.

TABLE 1

| | CPU | co-processor | memory requirements |
|---|---|---|---|
| Quality number | [cycles] | [cycles] | [bytes] |
| 79 | 39 | 22 | 3 |
| 68 | 28 | 12 | 3 |

The algorithm, or a quality control, which is part of the algorithm can have access to the contents of Table 1 too. Algorithms are started implicitly when a user switches to another channel for a main window and the, analog, source of the new channel is different from the, digital, source of the old channel. Other examples of starting algorithms or changing the resource requirement of an algorithm are:

when a user exchanges the contents of a main window and a picture in picture window by for example viewing the replay after a goal,

when the size of a video conferencing window changes, or

when a new application, for example a video conferencing application when a call arrives, is started in an additional window. The resource requirement of an algorithm changes too when the media data the algorithm processes changes. A change in th media data can be caused by the service provider that may transmit sources with different input parameters, for example when a movie which can be a 24 Hz film is interrupted by a commercial which can be a 60 Hz camera or it can be caused by motion or scene changes.

Within step 102 the functions a media processing algorithm comprises is determined by, for example, reading this information from some configuration file. This file describes that, for example, an algorithm for edge or sharpness enhancement comprises the functions as is illustrated in a schematic way in FIG. 2. Within this figure, a detail filter 200, a non-linear function 202, a gain 204, an adder 206, and noise measurement 208, is shown. The detail filter extracts higher frequency components from an input signal containing a video signal. Those components can be added to the input signal to increase the overall sharpness impression of the video signal. The non-linear function and following gain can reduce artifacts like clipping caused by the detail filter whereas the noise measurement function can adapt the sharpness enhancement dependent upon the noise level contained within the input signal.

Within step 104 the requested resources and the quality level per function are determined. In order to separate concerns, a quality control 210, see FIG. 2, shields the overall system control from the functions an algorithm comprises and is part of the algorithm.

Within the algorithm for edge or sharpness enhancement, the detail filter varies its requested resources for, for example, number of CPU cycles or number of bytes. The variation of requested resources is determined by the quality levels described by the coefficients for the filter and the type of filter: horizontal, vertical, or both. The non-linear function varies its requested resources for, for example, CPU cycles and is determined by the quality levels described by the quantization of the non-linear function, which can differ for the input signal and output signal. The gain varies its requested resources for, for example, a multiplier, shift and adder operations dependent upon whether it is stored as fixed values in a lookup table contained in memory, it is calculated by a multiplier or is calculated by shift and adder operations. The noise measurement varies its requested resources for, for example CPU cycles, because it can, for example, be switched on or off. The adder operation can vary its requested amount of resources by for example doing less precise additions. However, adder operations that cannot vary their requested amount of resources but provide a predefined quality level for a predefined amount of resources, for example CPU cycles, can be used too. The combination of all settings for requested resources and quality level per function, results in a large design space in which the complexity of the algorithm, or of a function of the algorithm, or of a combination of functions of the algorithm is set against its quality level. The result is summarized into, for example, a second lookup table as illustrated in Table 2. In this table, there are three main columns: “version”, which assigns a unique number to a row, “quality”, which groups all parameters concerning the output quality level a algorithm can provide, and “complexity”, which groups all parameters concerning the complexity of the algorithm. The mentioned parameters are not limiting, for example, store operations or communication means like bandwidth and cache can be used as parameters concerning the complexity of the algorithm. Furthermore, the numbers used for the quality and complexity within Table 2 are absolute, but may be normalized to operations per pixel within video independently from the chosen format. With this concept, a media algorithm designer designs the functions the media algorithm comprises to provide the correct functionality at different output quality levels.

TABLE 2

| | Quality | | | | | | Complexity | | | | | | |
|---|---|---|---|---|---|---|---|---|---|---|---|---|---|
| | | | Horizon- | | | | adder | | multipli- | | | Memory | |
| | | PSN | tal | Vertical | Temporal | | operations | | cations | | Shift | require | |
| | quality | R | process | process | process | | | co- | | co- | operations | ment | |
| Version | number | [dB] | ing | ing | ing | . . . | CPU | processor | CPU | processor | CPU | [bytes] | . . . |
| 1 | 79 | 45 | 1(yes) | 1(yes) | 1(yes) | . . . | 14 | 10 | 20 | 12 | 5 | 3 | . . . |
| 2 | 79 | 45 | 1(yes) | 1(yes) | 1(yes) | . . . | 24 | 0 | 32 | 0 | 28 | 5 | . . . |
| 3 | 68 | 39 | 1(yes) | 1(yes) | 0(no) | . . . | 10 | 8 | 12 | 4 | 6 | 3 | . . . |
| 4 | 67 | 39 | 1(yes) | 0(no) | 1(yes) | . . . | 9 | 4 | 10 | 4 | 6 | 2 | . . . |
| 5 | 61 | 37 | 0(no) | 1(yes) | 1(yes) | . . . | 10 | 0 | 11 | 0 | 7 | 3 | . . . |
| 6 | 54 | 35 | 1(yes) | 0(no) | 0(no) | . . . | 8 | 9 | 9 | 3 | 6 | 1 | . . . |
| . . . | . . . | . . . | . . . | . . . | . . . | . . . | . . . | . . . | . . . | . . . | . . . | . . . | . . . |
| N | 12 | 25 | 1(yes) | 0(no) | 0(no) | . . . | 4 | 0 | 3 | 0 | 12 | 0 | . . . |

Within step 106 the contents of the table is updated for the available software platform the algorithm has access to. For example, when the software platform does not support “temporal processing”, this columns is removed from the table and the effectuated rows are updated correspondingly. When for example “horizontal processing” is not supported the corresponding column an the rows which do not lead to any processing at all, like row 6 and N, are removed from the table. It is also possible to instantiate a run-time lookup table containing a mapping from software functions available within the software platform to software functions required by the algorithm instead of updating Table 2.

Within step 108 the contents of the table is updated for the available hardware platform the algorithm must be operated upon. For example, when the hardware platform does not provide a co-processor, this column is removed from the table and all rows are removed that only used a co-processor. It is also possible to instantiate a run-time lookup table containing a mapping from hardware available within the hardware platform to hardware required by the algorithm instead of updating Table 2.

After these steps, the functions an algorithm comprises, the plurality of quality levels the different functions provide, the plurality of output quality levels the algorithm provides and the hardware and software the algorithm requires from the hardware platform and software are known to the quality control. The overall system control only needs to know about the algorithm the resources the algorithm requests, the hardware it requires and the plurality of output quality levels th algorithm provides.

Within step 110 the overall system control allocates a resource budget to the algorithm accordance with a best overall system's output quality level. A best overall system's output quality level can be achieved when the system is in a steady state in which all algorithms that are running provide a predefined output quality level and the system is fully loaded. This means that additional algorithms can not be started without adjusting the output quality levels of the running algorithms. The budget that is allocated is substantially equal to the resources requested by the algorithm to provide a predefined output quality level. When the algorithm gets allocated less budget than requested, the algorithm may not provide the predefined output quality level and when the algorithm gets allocated more budget than requested, the algorithm may not use all resources. The overall system control 212, see FIG. 2, allocates the budget to the algorithm based upon the contents of Table 1. The overall system control 212 can allocate the budget to the algorithm based upon the contents of Table 2. In the latter case, the overall system control decides upon a more smooth transition of the output quality level provided by the algorithm. As is shown in Table 2, an abrupt transition of the output quality level provided by the algorithm is likely from version 2 to version 6, or from version 5 to version 6, because the processing changes in two dimensions. A more smooth transition is expected from version 2 to version 3, because the processing changes only in one dimension. The other “quality” parameters like the quality number or PSNR also provide information about the smoothness of transitions. The information about the hardware platform and software platform as derived in steps 106 and 108, can also be accessed by the overall system control. Selection of the output quality level provided by the algorithm is then based upon for example the available hardware. This is shown in Table 2, where version 1 and version 2 provide the same output quality level because their quality numbers are equal, but they distribute the required resources differently between the CPU and co-processors. The quality control can use this knowledge of distribution between CPU and co-processors to deal, amongst others, at run-time with overload situations in which the quality control can change the distribution, while the algorithm still provides the same output quality.

Within step 112 the quality control translates the allocated budget, or output quality level, to the algorithm as a whole into a quality level allocation to the different functions the algorithm comprises. This translation is based upon the contents of Table 2 and takes the combination of all settings for requested resources and quality level per function into account. The combination of all settings for requested resources determines the complexity of the algorithm a function of the algorithm and a combination of the functions of the algorithm. The complexity is expressed with a number. This number is weighted to get a single number for a specific hardware or software platform. FIG. 3 shows an example of the combination of the complexity and provided output quality level. Useful combinations are achieved at the highest output quality for the lowest complexity as is indicated by the drawn curve in FIG. 3. Each dot implies different quality settings or quality levels for the functions an algorithm comprises. The information about the hardware platform and software platform as derived in steps 106 and 108 is accessed by the quality control. The quality control uses this information to choose the best combination of the complexity and provided ouput quality level, because the best combination and the number of combinations can depend upon the hardware and/or software platform the functions must run upon. Changing the resolution of video data by for example sub-sampling the video data or deleting entire frames, lines or pixels is prevented by interpretation of the contents of Table 1 and Table 2 as previously described. The quality control also maximizes the perceptual quality because a user perceives a low output quality provided by the system, when the quality of, for example a movie, is changed continuously. Therefore quality levels are sparingly adjusted.

Within step 114, the quality control re-allocates the translated allocated budget to the functions the algorithm comprises implicitly, by assigning the corresponding quality level to the functions.

Within step 116 the functions and therefore the algorithm as a whole start operating using their allocated budget and set quality level. After completion of the algorithm, step 100 can be performed again or the final step 118 is reached.

The order in the described embodiment of the method of the current invention is not mandatory, a person skilled in the art may change the order of steps or perform steps concurrently using threading models, multi-processor systems or multiple processes without departing from the concept as intended by the current invention. Furthermore, the introduced quality control and overall system control express roles or concepts that can be used within the method of the current invention.

FIG. 4 illustrates the most important parts of an embodiment of the system according to the invention in a schematic way. The system, 400, composes a first memory 402 that contains per resource an amount of that resource an algorithm requests to provide a predefined ouput quality level. A CPU and a co-processor are examples of resources of which cycles can be requested. A second memory 404, contains a module to perform a first function of the algorithm, while a third memory 406, contains a module to perform a second function of the algorithm. Consider the edge or sharpness enhancement algorithm 214, as described in FIG. 2. The second memory 404 contains the module that performs detail filtering 200, while the third memory 406 contains the module that performs noise measurement 208. The system may also contain more memories containing modules that perform all the functions of the edge or sharpness enhancement algorithm as described in FIG. 2. The fourth memory, 408 contains a lookup table containing per quality level of a first plurality of quality levels the first function can provide, the amount of resources it requires. The fifth memory, 410 contains a lookup table containing per quality level of a second plurality of quality levels the second function can provide, the amount of resources the second function requires. After the overall system control allocates a budget per resource, as previously described, the sixth memory 412 contains per resource the amount of budget allocated to the algorithm. The overall system control can also assign the output quality level of the algorithm as a whole, thereby implicitly allocating a budget per resource to the algorithm. Furthermore, the memories 414 and 416 contain the quality levels provided by the first and second function of the algorithm respectively. Memory 418 contains a plurality of complexity numbers indicating a plurality of levels of complexity of operation of the first function of the algorithm. Memory 420 contains a complexity number indicating the least complex level of operation of the first function of the algorithm. In order to determine the content of memories 414 and 416 as previously described the quality control has access to the contents of memory 418 and 420. The contents of memories 402, 408, and 410, 418,, 420 can also be combined into one lookup table as illustrated in Table 2. This combined lookup table can then be stored into one memory instead of more separate memories. Furthermore, when the system is realised in silicon in which the functions and lookup table are hard-wired to eachother, the memories 412, 414 and 416 may be omitted. The quality control accesses the contents of memory 426 that contains a configuration file containing information about the available hardware within the system and it accesses the contents of memory 428 that contains a configuration file containing information about the available software algorithms within the system. The quality control has access to all previously described memories, whereas the overall system control only requires access to memories 402, 412, 426 and 428. However, when the overall system control has access to more memories, the output quality level transitions provided by the algorithm can become smoother. The system also comprises a first co-processor, 422, on which the first function of the algorithm can run and a second co-processor, 424, which on which the second function of the algorithm can run. An, optional, CPU, 430, operates the algorithm as a whole, because there needs to be some inter-process communication between the first and second function. When the system does not contain co-processors, the functions and therefore, the algorithm run on the CPU. When the first function can be operated at a plurality of levels of complexity, the first function runs at the least complex level on a dedicated co-processor 432, while the more complex level is run on the co-processor 422. It is also possible that the first function runs at each of the plurality of levels of complexity on either 432 or 422 or that the first function runs at each of the plurality of levels of complexity on CPU 430. This system can be realised in software intended to be operated as an application by a computer or any other standard architecture able to operate software. The system can be used to operate a digital television set 434. The system can also be realised in silicon wherein the mentioned lookup tables are replaced by logical building blocks that are hard-wired to each other and the mentioned processors and co-processors are omitted.

FIG. 5 illustrates, in a schematic way, a storage device that comprises a computer program product arranged to perform the method according to the invention. Here, 500 is a compact-disk comprising code 502.

FIG. 6 illustrates, in a schematic way, the most important parts of a television set that comprises an embodiment of the system according to the invention, Here an antenna, 600 receives a television signal. The antenna may also be for example a satellite dish, cable, storage device, internet, ethernet or any other device able to receive a television signal. A receiver, 602 receives the signal. The signal may be for example digital, analog, RGB or YUV. Besides the receiver 602, the television set contain a programmable component, 604, for example a programmable integrated circuit. This programmable component contains a system according to the invention 606. A television screen 608 shows images that are received by the receiver 602 and are processed by the programmable component 604, the system according to the invention 606 and other parts that are normally contained in a television set, but are not shown here.

FIG. 7 illustrates, in a schematic way, the most important parts of a set-top box that comprises an embodiment of the system according to the invention. Here, an antenna 700 receives a television signal. The antenna may also be for example a satellite dish, cable, storage device, internet, ethernet or any other device able to receive a television sisal. A set-top box 702, receives the signal. The signal may be for example digital, analogue, RGD or YUV. Besides the usual parts that are contained in a set-top box, but are not shown here, the set-top box contains a system according to the invention 704. The television set 706 can show the output signal generated from a received signal by the set-top box 702 together with the system according to the invention 704. The output signal may also be directed to a storage device like a VCR, DVD-RW or a haddisk or they may be directed to an internet link in stead of being directed to the television set.

1. A method of running an algorithm wherein the algorithm comprises a first function and a second function, the method comprising the following steps:
a first step of requesting an algorithm resource by the algorithm to provide a plurality of output quality levels,
a second step of determining that the first function provides a first plurality of quality levels and the second function provides a second plurality of quality levels,
a third step of allocating a budget to the algorithm to enable operating the algorithm at a output quality level, said output quality level being one of the plurality of output quality levels,
a fourth step of assigning a first quality level of the first plurality of quality levels to the first function and of assigning a second quality level of the second plurality of quality levels to the second function.

2. A method of running an algorithm according to claim 1, further comprising a fifth step of determining that the first function, while providing the first quality level, can be operated at a plurality of levels of complexity.

3. A method of running an algorithm according to claim 1, further comprising the following steps:
a sixth step of operating the algorithm at the output quality level.
a seventh stop of operating the first function at the first quality level while consuming a first amount of resources by the first function and operating the second function at the second quality level while consuming a second amount of resources by the second function.

4. A method of an algorithm according to claim 3, further comprising an eighth step of operating the first function at a least complex level of the plurality of levels of complexity.

5. A method of running an algorithm according to claim 1, wherein the allocated budget is substantially equal to the requested algorithm resource.

6. A method of running an algorithm according to claim 3, wherein the first amount of resources in addition to the second amount of resources is substantially equal to the allocated budget.

7. A method of running an algorithm according to claim 1, further comprising a ninth step of determining a hardware platform operating said method to determine the algorithm resource and the plurality of output quality levels.

8. A method of running an algorithm according to claim 1, further comprising an tenth step of determining a software platform operating said method to determine the algorithm resource and the plurality of output quality levels.

9. A system for running an algorithm wherein the algorithm comprises a first function and a second function, the system comprising:
function means (404, 406) conceived to contain the first function of the algorithm and a second function of the algorithm,
lookup means (402) conceived to contain a plurality of output quality levels that can be provided by the algorithm, a first plurality of quality level settings of the first function and a second plurality of quality level settings of the second function.

10. A system for running an algorithm according to claim 9, wherein at least one output quality level of said plurality of output quality levels can be provided by the algorithm for at least one first quality level setting of said first plurality of quality level settings and at least one second quality level setting of said second plurality of quality level settings.

11. A system for running an algorithm according to claim 10, further comprising a complexity means (418) conceived to contain a plurality of levels of complexity of operation for said at least one first quality level setting.

12. A system for an algorithm according to claim 9, further comprising a hardware configuration means (426) conceived to contain a hardware platform configuration of the system to determine at least said plurality of output quality levels.

13. A system for running a algorithm according to claim 9, further comprising a software configuration means (428) conceived to contain a software platform configuration of the system to determine at least said plurality of output quality levels.

14. A computer program product arranged to perform the method according to any of the claims 1 to 8.

15. A storage device (500) comprising a computer program product according to claim 14.

16. A television set (610) comprising a system according to any of the claims 9 to 13.

17. A set-top box (702) comprising a system according to any of the claims 9 to 13.
